(19) United States
(12) Patent Application Publication
(10) Pub. No.: US 2016/0308282 A1
(43) Pub. Date: Oct. 20, 2016

(54) ANTENNA STRUCTURE

(71) Applicant: Acer Incorporated, New Taipei City (TW)

(72) Inventor: Kun-Sheng CHANG, New Taipei City (TW)

(21) Appl. No.: 14/799,871

(22) Filed: Jul. 15, 2015

(30) Foreign Application Priority Data
Apr. 17, 2015 (TW) 104112324

(51) Int. Cl. H01Q 9/04

(52) U.S. Cl. CPC H01Q 9/0421

(57) ABSTRACT

An antenna structure includes a feeding element, a first radiation element, and a second radiation element. The feeding element is coupled to a signal source. The first radiation element is coupled to a ground voltage. The first radiation element is disposed adjacent to the feeding element. The second radiation element is coupled to the first radiation element. The second radiation element is substantially surrounded by the first radiation element.

### CROSS REFERENCE TO RELATED APPLICATIONS

This Application claims priority of Taiwan Patent Application No. 104112324 filed on Apr. 17, 2015, the entirety of which is incorporated by reference herein.

### BACKGROUND OF THE INVENTION

1. Field of the Invention

The disclosure generally relates to an antenna structure, and more particularly, to a wideband antenna structure.

2. Description of the Related Art

With advancements in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

An antenna is indispensable in a mobile device supporting wireless communication. However, since a mobile device often has limited interior space, there is not sufficient area for accommodating the required antenna element. Accordingly, it becomes a critical challenge for antenna designers to design a novel antenna with small size and wideband characteristics.

### BRIEF SUMMARY OF THE INVENTION

In a preferred embodiment, the invention is directed to an antenna structure including a feeding element, a first radiation element, and a second radiation element. The feeding element is coupled to a signal source. The first radiation element is coupled to a ground voltage. The first radiation element is disposed adjacent to the feeding element. The second radiation element is coupled to the first radiation element. The second radiation element is substantially surrounded by the first radiation element.

In some embodiments, the feeding element has a first end and a second end. The first end of the feeding element is coupled to the signal source, and the second end of the feeding element is open.

In some embodiments, the first radiation element has a first end and a second end. The first end of the first radiation element is open and adjacent to the second end of the feeding element, and the second end of the first radiation element is coupled to the ground voltage.

In some embodiments, a first coupling gap is formed between the first end of the first radiation element and the second end of the feeding element.

In some embodiments, the second radiation element has a first end and a second end. The first end of the second radiation element is coupled to a median portion of the first radiation element, and the second end of the second radiation element is open and adjacent to the first end of the first radiation element.

In some embodiments, a second coupling gap is formed between the second end of the second radiation element and the first end of the first radiation element.

In some embodiments, the feeding element substantially has an inverted-L shape.

In some embodiments, the first radiation element substantially has an inverted J-shape.

In some embodiments, the second radiation element substantially has an L-shape.

In some embodiments, the second radiation element substantially has an inverted T-shape.

### BRIEF DESCRIPTION OF DRAWINGS

The invention can be more fully understood by reading the subsequent detailed description and examples with references made to the accompanying drawings, wherein:

FIG. 1 is a diagram of an antenna structure according to an embodiment of the invention;

FIG. 2 is a diagram of an antenna structure according to an embodiment of the invention;

FIG. 3 is a diagram of return loss of an antenna structure according to an embodiment of the invention; and

FIG. 4 is a diagram of return loss of an antenna structure without a second radiation element according to an embodiment of the invention.

### DETAILED DESCRIPTION OF THE INVENTION

In order to illustrate the foregoing and other purposes, features and advantages of the invention, the embodiments and figures of the invention will be described in detail as follows.

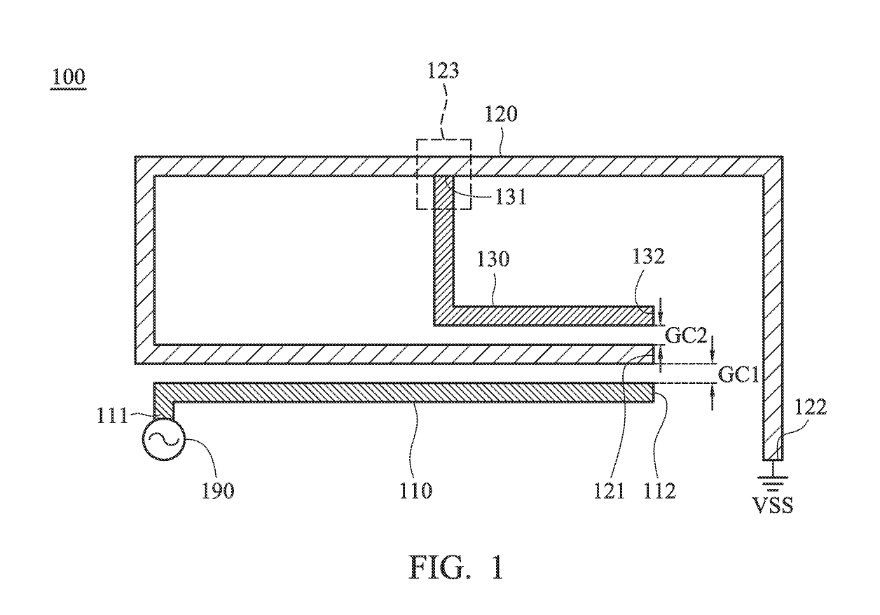

FIG. 1 is a diagram of an antenna structure 100 according to an embodiment of the invention. The antenna structure 100 may be applied in a mobile device, such as a smartphone, a tablet computer, or a notebook computer. As shown in FIG. 1, the antenna structure 100 includes a feeding element 110, a first radiation element 120, and a second radiation element 130. The feeding element 110, the first radiation element 120, and the second radiation element 130 may be made of metal materials, such as copper, silver, aluminum, iron, or their alloys. In addition, the feeding element 110, the first radiation element 120, and the second radiation element 130 may be disposed on a dielectric substrate (not shown), such as an FR4 (Flame Retardant 4) substrate.

The feeding element 110 is coupled to a signal source 190. The signal source 190 may be an RF (Radio Frequency) module of a mobile device, and may be configured to excite the antenna structure 100. The first radiation element 120 is coupled to a ground voltage VSS. The ground voltage VSS may be provided by a ground plane (not shown) of the mobile device. The first radiation element 120 is disposed adjacent to the feeding element 110. The second radiation element 130 is coupled to the first radiation element 120. The second radiation element 130 is substantially surrounded by the first radiation element 120.

More specifically, in the embodiment of FIG. 1, the inner components of the antenna structure 100 may be arranged as follows. It should be understood that the following arrangements are just exemplary, rather than limitations of the invention.

The feeding element 110 may substantially have an inverted L-shape. The feeding element 110 has a first end 111 and a second end 112. The first end 111 of the feeding element 110 is coupled to the signal source 190. The second end 112 of the feeding element 110 is open.

The first radiation element 120 may substantially have an inverted J-shape. The first radiation element 120 has a first end 121 and a second end 122. The first end 121 of the first radiation element 120 is open and adjacent to the second end 112 of the feeding element 110. The second end 122 of the first radiation element 120 is coupled to the ground voltage VSS. A first coupling gap GC1 is formed between the first end 121 of the first radiation element 120 and the second end 112 of the feeding element 110. The width of the first coupling gap GC1 is from about 1 mm to about 2 mm.

The second radiation element 130 may substantially have an L-shape. The second radiation element 130 has a first end 131 and a second end 132. The first end 131 of the second radiation element 130 is coupled to a median portion 123 of the first radiation element 120. The second end 132 of the second radiation element 130 is open and adjacent to the first end 121 of the first radiation element 120. A second coupling gap GC2 is formed between the second end 132 of the second radiation element 130 and the first end 121 of the first radiation element 120. The width of the second coupling gap GC2 is from about 1 mm to 2 mm.

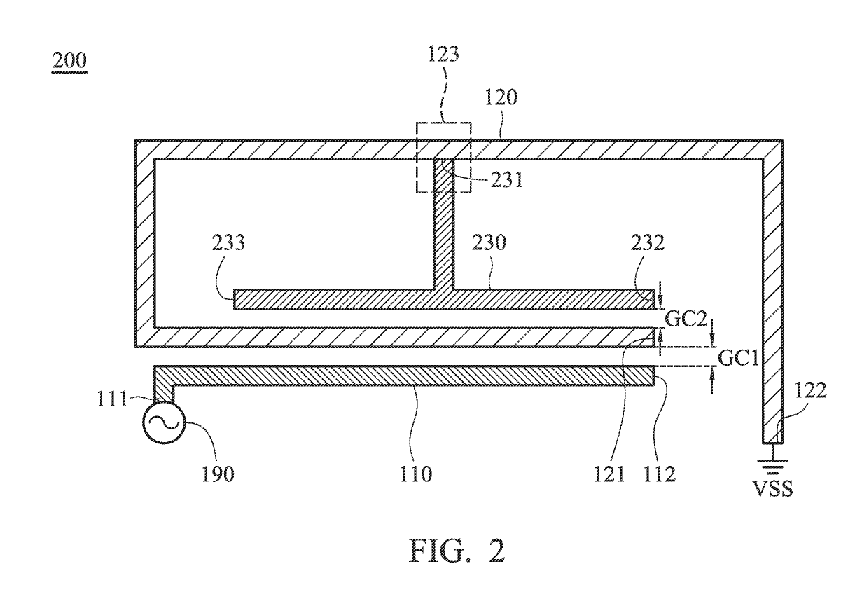

FIG. 2 is a diagram of an antenna structure 200 according to an embodiment of the invention. FIG. 2 is similar to FIG. 1. In the embodiment of FIG. 2, the antenna structure 200 includes a feeding element 110, a first radiation element 120, and a second radiation element 230. The characteristics of the feeding element 110 and the first radiation element 120 have been described in the embodiment of FIG. 1. The second radiation element 230 may substantially have an inverted T-shape. More specifically, the second radiation element 230 has a first end 231, a second end 232, and a third end 233. The first end 231 of the second radiation element 230 is coupled to a median portion 123 of the first radiation element 120. The second end 232 of the second radiation element 230 is open and adjacent to the first end 121 of the first radiation element 120. The third end 233 of the second radiation element 230 is open. The second end 232 and the third end 233 of the second radiation element 230 substantially extend away from each other. A second coupling gap GC2 is formed between the second end 232 of the second radiation element 230 and the first end 121 of the first radiation element 120. The width of the second coupling gap GC2 is from about 1 mm to about 2 mm.

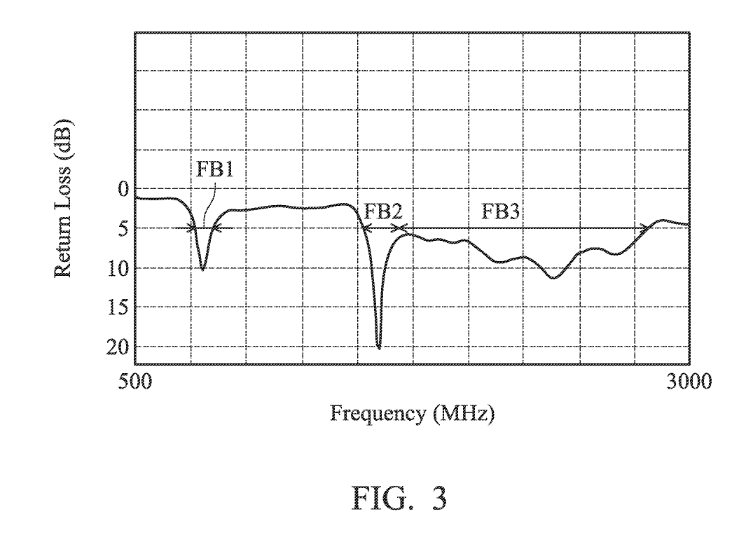

FIG. 3 is a diagram of return loss of the antenna structure 200 according to an embodiment of the invention. The horizontal axis represents operation frequency (MHz), and the vertical axis represents return loss (dB). According to the criterion of 5 dB return loss, the antenna structure 200 can operate in a low-frequency band FB1, a median-frequency band FB2, and a high-frequency band FB3. For example, the low-frequency band FB1 may be from about 737 MHz to about 894 MHz (American LTE standard), or from about 790 MHz to about 960 MHz (European LTE standard). The median-frequency band FB2 may be from about 1575 MHz to about 1612 MHz. The high-frequency band FB3 may be from about 1710 MHz to about 2700 MHz. Therefore, the antenna structure of the invention can cover at least the wideband operations of LTE (Long Term Evolution) and GPS (Global Positioning System) bands.

The operation theory of the antenna structure 200 is described as follows. A first resonant path is formed from the feeding element 110 through the first coupling gap GC1 to the first radiation element 120. The first resonant path is excited to generate the aforementioned low-frequency band FB1. A second resonant path is formed from the feeding element 110 through the first coupling gap GC1, the second coupling gap GC2 and the second radiation element 230 to the first radiation element 120. The second resonant path is excited to generate the aforementioned median-frequency band FB2. A third resonant path is formed by the feeding element 110. The third resonant path is excited to generate the aforementioned high-frequency band FB3. It should be understood that in the invention, the second radiation element 230 (or 130) can additionally generate a GPS resonant mode and increase the total bandwidth of the antenna structure 200 (or 100). Because the second radiation element 230 is surrounded by the first radiation element 120 and is positioned at the interior of the first radiation element 120, the incorporation of the second radiation element 230 does not further increase the total area occupied by the antenna structure 200. According to the practical measurements, the total length of the antenna structure 200 is just 35 mm, and the total width of the antenna structure 200 is a mere 11 mm. The size of the proposed antenna structure is reduced by 36% in comparison to that of a conventional LTE and GPS antenna. With such a design, the antenna structure 200 of the invention has the advantages of both reducing the total size and increasing the bandwidth, and therefore it is suitable for application in a variety of small-size mobile communication devices.

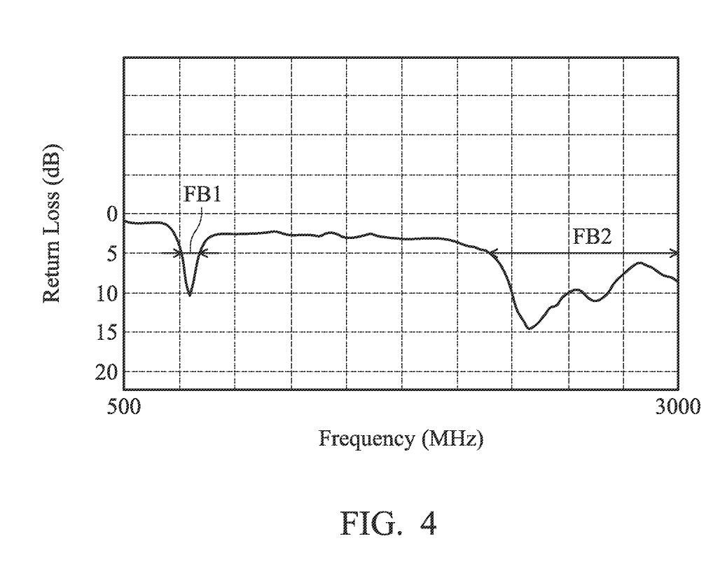

FIG. 4 is a diagram of return loss of the antenna structure 200 without the second radiation element 230 according to an embodiment of the invention. The horizontal axis represents operation frequency (MHz), and the vertical axis represents return loss (dB). If the second radiation element 230 is removed from the antenna structure 200, according to the criterion of 5 dB return loss, the antenna structure 200 can only operate in a low-frequency band FB1 and a high-frequency band FB3. In comparison with the embodiment of FIG. 3, the median-frequency band FB2 (GPS band) of the antenna structure 200 completely disappears, it should be noted. On the other hand, the bandwidth of the high-frequency band FB3 of the antenna structure 200 is significantly decreased. According to a comparison between FIG. 3 and FIG. 4, the incorporation of the second radiation element 230 significantly contributes to the GPS band and bandwidth of the antenna structure 200, and it is an important feature of the invention.

Note that the above element sizes, element shapes, and frequency ranges are not limitations of the invention. An antenna designer can fine-tune these settings or values according to different requirements. It should be understood that the antenna structure of the invention is not limited to the configurations of FIGS. 1-4. The invention may include any one or more features of any one or more embodiments of FIGS. 1-4. In other words, not all of the features displayed in the figures should be implemented in the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An antenna structure, comprising:
a feeding element, coupled to a signal source;
a first radiation element, coupled to a ground voltage, wherein the first radiation element is disposed adjacent to the feeding element; and
a second radiation element, coupled to the first radiation element, wherein the second radiation element is substantially surrounded by the first radiation element.

2. The antenna structure as claimed in claim 1, wherein the feeding element has a first end and a second end, the first end of the feeding element is coupled to the signal source, and the second end of the feeding element is open.

3. The antenna structure as claimed in claim 2, wherein the first radiation element has a first end and a second end, the first end of the first radiation element is open and adjacent to the second end of the feeding element, and the second end of the first radiation element is coupled to the ground voltage.

4. The antenna structure as claimed in claim 3, wherein a first coupling gap is formed between the first end of the first radiation element and the second end of the feeding element.

5. The antenna structure as claimed in claim 3, wherein the second radiation element has a first end and a second end, the first end of the second radiation element is coupled to a median portion of the first radiation element, and the second end of the second radiation element is open and adjacent to the first end of the first radiation

6. The antenna structure as claimed in claim 5, wherein a second coupling gap is formed between the second end of the second radiation element and the first end of the first radiation element.

7. The antenna structure as claimed in claim 1, wherein the feeding element substantially has an inverted-L shape.

8. The antenna structure as claimed in claim 1, wherein the first radiation element substantially has an inverted J-shape.

9. The antenna structure as claimed in claim 1, wherein the second radiation element substantially has an L-shape.

10. The antenna structure as claimed in claim 1, wherein the second radiation element substantially has an inverted T-shape.
